(19) United States
(12) Patent Application Publication
(10) Pub. No.: US 2008/0081871 A1
(43) Pub. Date: Apr. 3, 2008

(54) Water dispersible polyisocyanates

(76) Inventors: Amit Sehgal, Marlton, NJ (US); Satyen Trivedi, East Windsor, NJ (US); Lichang Zhou, Lawrenceville, NJ (US)

Correspondence Address: KEVIN E. MC VEIGH;RHODIA INC., 8 CEDAR BROOK DRIVE (CN 7500), CRANBURY, NJ, 08512-7500, US

(21) Appl. No.: 11/904,877

(22) Filed: Sep. 28, 2007

Related U.S. Application Data
(60) Provisional application No. 60/848,152, filed on Sep. 29, 2006.

(51) Int. Cl. C08G 18/02

(52) U.S. Cl. 524/591; 525/452; 528/59

(57) ABSTRACT

An aqueous reactive coating composition contains a mixture of:
(a)(1) one or more hydrophobic polyisocyanate oligomers,
(a)(2) one or more surface active agents, and
(a)(3) one or more fluorinated solvents, and provides high gloss films and exhibit improved pot-life.

### FIELD OF THE INVENTION

The invention relates generally to water dispersible polyisocyanate-based compounds and compositions containing hydrophobic polyisocyanate, a surface active agent, and fluorinated solvent. The invention further relates to water dispersible polyisocyanate based compositions in two-component water-based polyurethane coatings used to produce high gloss films on a substrate. The invention also relates to the process of using and producing the water dispersible polyisocyanate-based compositions.

### BACKGROUND OF THE INVENTION

As used herein, the term “two-component” refers to the minimum number of solutions and/or dispersions, which are mixed together to provide a curable coating composition. Once mixed, the resulting curable coating composition may be applied to a surface.

In two-component waterborne polyurethane coatings, a water dispersible polyisocyanate, also referred to as water-emulsifiable, waterborne or hydrophilic polyisocyanate, is added to an aqueous polymer dispersion. The water dispersible polyisocyanate may also be added directly in water to give a pre-dispersion and the resulting solution may then be mixed with the aqueous polymer dispersion. The aqueous polymer dispersion is usually a polyurethane dispersion (“PUD”) or a polyol. These two-component waterborne polyurethane coating compositions are currently of great importance in the polyurethane coatings industry due to their excellent film properties and their durability. More significantly, they are eco-friendly with a low or negligible volatile organic content (VOC). The description of typical water dispersible polyisocyanate compositions, their use in two-component waterborne polyurethane coating compositions, and the process which facilitates easy dispersion of water dispersible polyisocyanates in water with a greatly reduced requirement of added organic solvents (VOC) is contained in U.S. patent application Ser. No. 11/006,943. Notwithstanding the environmental benefits, providing a water emulsifiable polyisocyanate composition is inherently difficult primarily due to the reactivity with water itself, which limits the “pot life” of the two-component mixture. In addition to these challenges coating composition stability is formulation dependent. It is generally difficult to produce high gloss water-based two-component polyurethane coatings due to incompatibility of the water dispersible polyisocyanate with the aqueous polymer dispersion, particularly when the aqueous polymer dispersion is a PUD.

Gloss generally refers to the optical appearance of the film as being highly reflective and is measured by means known to a person of ordinary skill in the art. Accordingly, the use of water dispersible polyisocyanates has been severely limited in various applications, e.g., wood coatings, concrete or floor coatings, or the like, due to the incompatibility of water dispersible polyisocyanates with aqueous polymer dispersions, which often result in a low gloss or “Matte Finish”. It is the purpose of this invention to provide a robust water dispersible polyisocyanate composition with a fluorinated solvent that is relatively insensitive to variations in formulation resulting in greatly improved visual characteristics of the film.

U.S. Pat. No. 5,587,421 to Peter Weyland et al. discloses the use of aprotic solvents such as carbonic esters or lactones in water-based polyurethane coatings to reduce viscosity and improve mixing and emulsification properties, such as pot-life and dispensability. However, high gloss films are not readily attainable with two-component waterborne polyurethane coating compositions, particularly in the case of PUD based compositions. An easy to use robust water emulsifiable polyisocyanate that facilitates film formation and yields clear high gloss coatings continues to be a challenge for the polyurethane coatings industry.

It is an object of the present invention to provide such water dispersible polyisocyanate coating compositions, which provide the above advantages.

### SUMMARY OF THE INVENTION

In a first aspect, the present invention is directed to a water emulsifiable polyisocyanate composition, comprising:

(a)(1) one or more hydrophobic polyisocyanate oligomers,
(a)(2) one or more surface active agents, and
(a)(3) one or more fluorinated solvents.

In a second aspect, the present invention is directed to an aqueous reactive coating composition, comprising a mixture of:

(a)(1) one or more hydrophobic polyisocyanate oligomers,
(a)(2) one or more surface active agents, and
(a)(3) one or more fluorinated solvents, and
(b) an aqueous polymer dispersion.

The aqueous reactive coating composition of the present invention provides high gloss films and exhibit improved pot-life, particularly where the aqueous polymer dispersion is a polyurethane.

### BRIEF DESCRIPTION OF THE DRAWINGS

FIG. 1 shows optical micrographs of films cast from polyurethane dispersion/water dispersible polyisocyanate emulsions with different fluorinated solvent content.

FIG. 2 shows optical micrographs of films cast from polyurethane dispersion/water dispersible polyisocyanate emulsions containing different solvents at varying mass concentrations.

FIG. 3 contains optical micrographs of films showing improvement in film appearance with fluorinated solvent for different aqueous polymer dispersions. Improvement in film appearance is observed for films cast from two different polyurethane dispersions/water dispersible polyisocyanate emulsions and with a polyol latex/water dispersible polyisocyanate emulsion.

### DETAILED DESCRIPTION OF INVENTION AND PREFERRED EMBODIMENTS

Solvents play a critical role in film formation and are recommended in base formulations for two-component waterborne polyurethane coatings. As known in the art and as described herein, two-component waterborne polyurethane coating compositions are not limited to only two-components and refer to the water dispersible polyisocyanate and the aqueous polymer dispersion parts in the curable coating composition. They generally contain other components such as solvents and additives that may be blended with either of the components. As discussed above, solvents may be added to water dispersible polyisocyanate compositions to dilute the composition or reduce its viscosity. Generally a formulation for a two-component waterborne polyurethane coating will comprise a polyisocyanate part which is diluted with up to about 30% solvent. Due to ecological and toxicological constraints it is becoming increasingly difficult to use certain types of solvents and to use solvents at elevated levels. Currently, aprotic solvents, which include solvents such as butyl acetate, dipropylene glycol dimethy ether (DMM) and propylene glycol methyl ether acetate (PMA) are used to dilute water dispersible polyisocyanate compositions. However, coating formulations based on water dispersible polyisocyanate mixtures comprising aprotic solvents, particularly PUD formulations, only produce films exhibiting low gloss or “Matte finish” characteristics. This severely limits the applications for which these water dispersible polyisocyanate compositions may be used.

We have found that using fluorinated solvent in a two-component waterborne polyurethane coating composition provides high gloss films when the composition is blended with a polyurethane dispersion or polyol, and particularly with polyurethane dispersions. Typically, the improvement in gloss may be provided when the fluorinated solvent is added to the water dispersible polyisocyanate. Compositions in accordance with the invention are also useful for controlling gloss level.

In one embodiment, the water emulsifiable polyisocyanate composition comprises:

from greater than 0 to less than 100 wt %, more typically from about 50 to about 95 wt %, of the one or more hydrophobic isocyanate oligomers,

from greater than 0 to about 40 wt %, more typically from about 2 to about 20 wt %, of the one or more surface active agents, and

from greater than 0 to about 40 wt %, more typically from about 5 to about 15 wt %, of the one or more fluorinated solvent.

In accordance with the invention a first component (a) of a two-component polyurethane coating composition generally comprises the water emulsifiable polyisocyanate composition (a), which comprises (a)(1) hydrophobic polyisocyanate, (a)(2) a surface active agent, and (a)(3) fluorinated solvent. A second component (b) is generally an aqueous polymer dispersion, which may be a polyurethane dispersion or a polyol, and is more typically a polyurethane dispersion. While it is preferred that the fluorinated solvent be added to the first component, it should be understood that the fluorinated solvent may also be added to the two-component polyurethane coating composition at any suitable processing time. The present invention also relates to a process for the preparation of water dispersible polyisocyanate base compositions.

### Part (a)—Water Dispersible Polyisocyanate Composition

(a)(1)—Hydrophobic Polyisocyanate

Any suitable hydrophobic polyisocyanate may be used in accordance with the invention. Hydrophobic polyisocyanates are generally aliphatic, cylcoaliphatic or aromatic diisocyanates or polyisocyanates that have NCO functionality higher than 2, more typically between 2.5 and 10, and even more typically between 2.8 and 6.0, and are in some cases mixed with surfactants or reacted with compounds having at least one hydrophilic group and having at least one group reactive toward isocyanate. As used herein in reference to a polyisocyanate oligomer, the terminology “NCO functionality” means the number of isocyanate (“NCO”) groups per molecule of polyisocyanate oligomer. Any suitable polyisocyanate may be used to produce a hydrophobic polyisocyanate in accordance with the invention.

### Suitable isocyanates useful in accordance with the invention are set forth in more detail below.

These compounds may typically contain structures that are common in this field, for example, pre-polymers originating from the condensation of polyol (For example trimethylopropane) in general triol (typically primary alcohol, see below on the definition of the polyols) and above all the most common ones, namely those of isocyanurate type, also called trimer, uretdione structures, also called dimer, biuret or allophanate structures or a combination of this type of structures on one molecule alone or as mixture.

If it is desired to greatly lower the solvent content of the composition, especially when it is in the form of emulsion, it is preferable to employ mixtures of this type naturally (that is to say without addition of solvent) with low viscosity. The compounds exhibiting this property are above all the derivatives (isocyanurate type, also called trimer, uretdione structures, also called dimer, biuret or allophanate structures or a combination of this type of structures on one molecule alone or as mixture) partially and/or totally of the aliphatic isocyanates in which the isocyanate functional groups are joined to the backbone through the intermediacy of ethylene fragments (For example polymethylene diisocyanates, especially hexamethylene diisocyanate) or a cycloaliphatic moiety (For example in isophorone diisocyanate) and of the arylenedialkylene diisocyanates in which the isocyanate functional group is at a distance of at least two carbons from the aromatic nuclei, such as (OCN—[CH₂]ₜ-φ-[CH₂]ᵤ—NCO) with t and u greater than 1. These compounds or mixtures typically have a viscosity at most equal to about 20000 centipoises (or millipascal second), typically to about 2000 centipoises (or millipascal second).

It may be useful to bring the mixture to these viscosity values by the addition of a minimum quantity of appropriate solvent(s). In this invention the preferred solvents are fluorinated solvents or a mixture of solvents where at least one of the solvents is a fluorinated solvent. As already mentioned above, the isocyanates concerned may be mono-, di- or even polyisocyanates, or reaction products of polyisocyanates with a polyol or polyester or a compound with functional groups reactive with NCO functionalities. These derivatives may typically contain structures of isocyanurate type, also called trimer, uretdione structures, also called dimer, biuret or allophanate structures or a combination of this type of structures in one molecule alone or as mixture.

In one embodiment, the hydrophobic polyisocyanate oligomer comprises a product of a condensation reaction of isocyanate monomers. Suitable isocyanate monomers include, for example, aliphatic and cycloaliphatic diisocyanate monomers, such as 1,6-hexamethylene diisocyanate bis(isocyanato-methylcyclohexane) and the cyclobutane-1,3-diisocyante, cyclohexane-1,3-diisocyanate, cyclohexane-1,4-diisocyanate; Norborne diisocyanate, isophorone diisocyanate, 3-isocyanatomethyl-3,5,5-trimethylcyclo-hexylisocyanate, and aromatic diisocyanate monomers, include, for example, 2,4- or 2,6-toluene diisocyanate; 2,6-4,4′-diphenylmethane diisocyanate; 1,5-naphthalene diisocyanate and p-phenyl diisocyanate. In one embodiment, the isocyanate monomer comprises 1,6-hexamethylene diisocyanate.

In one embodiment, the hydrophobic polyisocyanate oligomer is made by condensation of isocyanate monomers to form a mixture of oligomeric species, wherein such oligomeric species each comprise two or more monomeric repeating units per molecule, such as, for example, dimeric species, consisting of two monomeric repeating units per molecule (“dimers”), and trimeric species consisting of three monomeric repeating units per molecule (“trimers”), and wherein such monomeric repeating units are derived from such monomers. In one embodiment, the polyisocyanate oligomer further comprises polyisocyanate oligomeric species comprising greater than three monomeric repeating units per molecule, such as, for example, the respective products of condensation of two dimers (“bis-dimers”) of two trimers (“bis-trimers”), or of a dimer with a trimer as well as higher order analogs of such polycondensation products.

In one embodiment, the hydrophobic polyisocyanate oligomer comprises one or more oligomeric species comprising two or more monomeric units per molecule, typically including: (i) compounds with at least one isocyanurate moiety, (ii) compounds with at least one uretidinedione moiety and (iii) compounds with at least one isocyanurate moiety and at least one uretidinedione moiety.

(a)(2) Surface Active Agent

The terminology “surface active agent” is used herein according to its conventional meaning, that is, any compound that reduces surface tension when dissolved in water or in an aqueous solution.

In one embodiment, the surface active agent comprises a polyisocyanate surface active agent. Suitable polyisocyanate surface active agents include, for example, those made by grafting ionic substituents, polyalkylene oxide chains, or ionic substituents and polyalkylene oxide chains onto a polyisocyanate molecule. Certain suitable surfactant-based polyisocyanates for use in accordance with the invention are described in U.S. patent application Ser. No. 11/006,943 which is herein incorporated by reference. These polyisocyanates include compositions based on isocyanate(s), typically not masked, where the composition comprises at least one compound containing an anionic functional group and typically a polyethylene glycol chain fragment of at least 1, more typically of at least 5 ethyleneoxy units,

In one embodiment, the surface active agent comprises one or more surfactant compounds selected from anionic surfactants, such as sulfate or sulfonate surfactants, cationic surfactants, such as quaternary ammonium surfactants amphoteric/zwitterionic surfactants, such as betaine surfactants, nonionic surfactants, such as an alkoxylated alcohol, and mixtures thereof. These surface-active agents may also be chosen from ionic compounds [especially aryl and/or alkyl sulphate or phosphate (of course aryl includes especially alkylaryls and alkyl includes especially aralkyls), aryl- or alkyl phosphonate, -phosphinate, sulphonate, fatty acid salt and/or zwitterionic] and among the nonionic compounds those blocked at the end of a chain or not. (However, it should be noted that nonionic compounds which have alcoholic functional groups on at least one of the chains seem to have a slightly unfavorable effect on (auto)emulsion even though they have a favorable effect on other aspects of the composition, for example, painting; bearing this in mind, it is preferable that the content of this type of compound represent at most one third, typically at most one fifth, typically at most one tenth of the mass of the said anionic compounds according to the invention.)

In one embodiment, the surfactant compound contains a hydrophilic part formed of said anionic functional group, of said (optional) polyethylene glycol chain fragment and of a lipophilic part based on a hydrocarbon radical.

The lipophilic part of the surfactant compound is generally chosen from alkyl groups and aryl groups. When the number of ethylene glycol functional group is at most equal to 5, the simple alkyls are typically branched, typically from C₈ to C₁₂, the aralkyls C₁₂ to C₁₆, the alkylaryls from C₁₀ to C₁₄ and the simple aryls are C₁₀ to C₁₆. Otherwise the lipophilic part can vary widely above all when the number of ethylene glycol units is above 10, it may thus constitute a hydrocarbon radical of at least 1, typically of at least 3 and containing at most 25 typically at most 20 carbon atoms.

In one embodiment, the surfactant compound comprises one or more compounds according to formula (I).

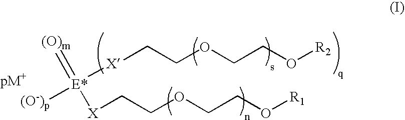

wherein:

q is 0 or 1;

p is 1 or 2;

m is 0, 1 or 2;

X and X′ are each independently divalent aliphatic linking groups. typically, methylene or dimethylene;

s is 0 or an integer from 1 to 30, typically from 5 to 25, more typically from 9 to 20;

n is 0 or an integer from 1 to 30, typically from 5 to 25, more typically from 9 to 20;

E is an atom chosen from carbon and the metalloid elements of atom row at least equal to that of phosphorus and belonging to column VB or to the chalcogens of atom row at least equal to that of sulphur; and

R₁ and R₂ are each independently hydrocarbon radicals, typically chosen from optionally substituted aryls, alkyl, and alkenyl moieties, more typically, (C₁-C₆)alkyl, and

M⁺ is a counterion.

Although this does not form part of the preferred compounds, it is appropriate to note that s and/or n can be equal to zero, with the condition that E is phosphorus and that when s and n are equal to zero, R₁ and/or R₂ are respectively alkyls from C₈ to C₁₂, typically branched, or an aralkyl from C₁₂ to C₁₆ or an alkylaryl from C₁₀ to C₁₄.

One of the divalent radicals X and X′ can also be a radical of type ([EOₘ(O⁻)ₚ]) so as to form pyroacids like the symmetric or otherwise diesters of pyrophosphoric acid.

The total carbon number of the anionic compounds aimed at by the present invention is typically at most about 100, typically at most about 50.

The divalent radicals X and optionally X′ are typically chosen from the divalent radicals consisting of (the left-hand part of the formula being bonded to the first E):

when E is P, one of the X or X′ may be O—P(O)(O⁻)—X″—;

when E is P, one of the X or X′ may be —O—(R₁₀—O)P(O)—X″—; (R₁₀ being defined below) (X″ denoting an oxygen or a single bond);

a direct bond between E and the first ethylene of the said polyethylene glycol chain fragment;

methylenes which are optionally substituted and in this case typically partly functionalized;

the arms of structure —Y— and of structure -D-Y—, —Y-D- or —Y-D-Y′,

where Y denotes a chalcogen (typically chosen from the lightest ones, namely sulfur and above all oxygen), metalloid elements of the atom rows at most equal to that of phosphorus and belonging to column VB in the form of derivatives of amines or of tertiary phosphines (the radical providing the tertiary character being typically of at most 4 carbons, typically of at most 2 carbons);

where D denotes an alkylene, which is optionally substituted, including functionalized, D being typically ethylene or methylene, typically ethylene in the structures -D-Y— and above all —Y-D-Y′, and methylene in the structures —Y-D-,
thus, E denotes an atom chosen from carbon atoms (typically in this case m=1 and p=1, the prototype of this type of compound is an alcohol acid [For example, lactic or glycolic acid], which is polyethoxylated) the atoms giving salts containing an element of group VB (elements As or Sb) (elements of column VB) (typically in this case m=1 or 0 and p=1 or 2), chalcogen atoms of row higher than oxygen (typically in this case m=1 or 2 and p=1 and q=0).

In one embodiment, E is a phosphorus atom and R₁ and R₂ are each independently (C₁-C₆)alkyl.

Thus, in the case where E is chalcogen the formula I is typically simplified to formula (II):

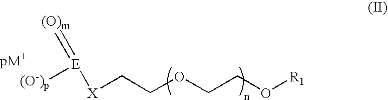

wherein E, m, n, X, p, R₁ and M⁺ are each as described above.

E typically denotes carbon, phosphorus or sulfur, most typically phosphorus. In the case wherein E=P and q=0, the formula (I) simplifies to formula (II-a):

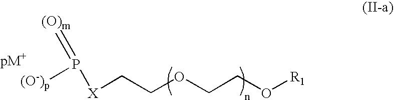

wherein p, m, n, X, R₁, and M⁺ are each as described above.

The optional functionalization of the alkylenes and especially methylenes (X and X′) is done by hydrophilic functional groups (tertiary amines and other anionic functional groups including those which are described above [EOₘ(O⁻)ₚ]).

The counter-cation M⁺ is typically monovalent and is chosen from inorganic cations and organic cations, typically non-nucleophilic and consequently of quaternary or tertiary nature (especially oniums of column V, such as phosphonium, ammoniums, or even of column VI, such as sulphonium, etc.) and mixtures thereof, in most cases ammoniums, in general originating from an amine, typically tertiary. The presence on the organic cation of a hydrogen that is reactive with the isocyanate functional group is typically avoided, hence, the preference for tertiary amines.

The inorganic cations may be sequestered by phase transfer agents like crown ethers.

The pKa of the cations (organic or inorganic) is typically between 8 and 12.

The cations and especially the amines corresponding to the ammoniums typically do not exhibit any surface-active property but it is desirable that they should exhibit a good solubility, sufficient in any event to ensure it is in the compounds containing an anionic functional group and typically a polyethylene glycol chain fragment, in aqueous phase, this being at the concentration for use. Tertiary amines containing at most 12 atoms, typically at most 10 atoms, typically at most 8 atoms of carbon per “onium” functional group are preferred (it must be remembered that it is preferred that there should be only one thereof per molecule). The amines may contain another functional group and especially the functional groups corresponding to the amino acid functional groups and cyclic ether functional groups like N-methylmorpholine, or not. These other functional groups are typically in a form that does not react with isocyanate functional groups and do not significantly alter the solubility in aqueous phase.

It is highly desirable that the anionic compounds according to the present invention should be in a neutralized form such that the pH which it induces when being dissolved in, or brought into contact with water, is at greater than or equal to 3, more typically greater than or equal to 4, and even more typically greater than or equal to 5, and less than or equal to 12, more typically less than or equal to 11, and even more typically less than or equal to 10.

When E is phosphorus it is desirable to employ mixtures of monoester and of diester in a molar ratio of between about 1/10 and about 10, typically between about 1/4 and about 4. Such mixtures may additionally contain from 1% up to about 20% (it is nevertheless preferable that this should not exceed about 10%) by mass of phosphoric acid (which would be typically at least partially converted into salt form so as to be within the recommended pH ranges), and from 0 to about 5% of pyrophosphoric acid esters.

The mass ratio between the surface-active compounds (including the said compound containing an anionic functional group and typically a polyethylene glycol chain fragment) and the polyisocyanates is very typically between 4 and about 20%, typically between about 5% and about 15% and even more typically between about 6% and about 13%.

After being converted into dispersion or emulsion in an aqueous phase, a water dispersible polyisocyanate composition according to the invention may have a water content of about 10 to about 70%. The emulsion is an oil-in-water emulsion.

Alternatively, for the preparation of a grafted surface active or hydrophilic polyisocyanate, the isocyanates described above, alone or in combination, may be mixed with compounds which have at least one, typically one, hydrophilic group and at least one, typically one, group reactive with isocyanate, for example hydroxyl, mercapto or primary or secondary amino (NH group for short) as described in U.S. Pat. No. 5,587,421.

The hydrophilic group may be, for example, a nonionic group, an ionic group or a group convertible into an ionic group.

Anionic groups or groups convertible into anionic groups are, for example, carboxyl and sulfo groups.

Examples of suitable compounds are hydroxycarboxylic acids, such as hydroxypivalic acid or dimethylol propionic acid, and hydroxy and aminosulfonic acids.

Cationic groups or groups convertible into cationic groups are, for example, quaternary ammonium groups and tertiary amino groups.

Groups convertible into ionic groups are typically converted into ionic groups before or during dispersing of the preferred compositions in water.

In order to convert, for example, carboxyl or sulfo groups into anionic groups, inorganic and/or organic bases, such as sodium hydroxide, potassium hydroxide, potassium carbonate, sodium bicarbonate, ammonia or primary, secondary or in particular tertiary amines, e.g. triethylamine or dimethylaminopropanol, may be used.

For converting tertiary amino groups into the corresponding cations, for example ammonium groups, suitable neutralizing agents are inorganic or organic acids, for example hydrochloric acid, acetic acid, fumaric acid, maleic acid, lactic acid, tartaric acid, oxalic acid or phosphoric acid and suitable quaternizing agents are, for example, methyl chloride, methyl iodide, dimethyl sulfate, benzyl chloride, ethyl chloroacetate or bromoacetamide. Any suitable neutralizing and quaternizing agents may be used.

The content of ionic groups or of groups convertible into ionic groups is typically from 0.1 to 3 mol/kg of the surface active polyisocyanates.

Nonionic groups are, for example, polyalkylene ether groups, in particular those having from 5 to 80 alkylene oxide units. Polyethylene ether groups or polyalkylene ether groups, which contain from 5 to 20, even more typically from 5 to 15 ethylene oxide units in addition to other alkylene oxide units, e.g. propylene oxide, are preferred.

Examples of suitable compounds include polyalkylene ether alcohols.

The content of hydrophilic nonionic groups, in particular of polyalkylene ether groups, is typically from 0.5 to 20%, particularly typically from 1 to 15% by weight, based on the surface active polyisocyanates.

The preparation of the surface active polyisocyanates is well known in the art and is disclosed in DE-A-35 21 618, DE-A-40 01 783 and DE-A-42 03 510.

In the preparation of the surface active polyisocyanates, the compounds containing at least one hydrophilic group and at least one group reactive toward isocyanate may be reacted with some of the isocyanate, and the resulting hydrophilized polyisocyanates can then be mixed with the remaining polyisocyanates. However, the preparation may also be carried out by adding the compounds to the total amount of the polyisocyanates and then effecting the reaction in situ.

Preferred surface active polyisocyanates are those containing hydrophilic, nonionic groups, in particular polyalkylene ether groups. The water emulsifiability is typically achieved exclusively by the hydrophilic nonionic groups.

In one embodiment, the surface active isocyanate compound comprises one or more polyalkylene ether-grafted isocyanate compounds according to formula (III):

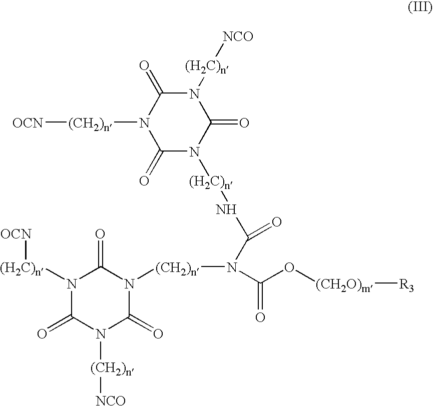

wherein:

each n′ is independently an integer of from 1 to about 20, and

m′ is an integer of from 2 to about 30, and

R₃ is an aliphatic or aromatic hydrocarbon radical, typically (C₁-C₆)alkyl.

In another embodiment, the surface active polyisocyanate comprises an anionic-functionalized isocyanate compound, such as, for example, 3-(cyclohexylamino)-1-propan-sulfonic acid and salts thereof.

(a)(3) Fluorinated Solvent

Regulations now limit the use of many solvents which have been implicated in the destruction of the stratospheric ozone. Many companies are searching for alternative solvents that are cost effective, non-flammable, non-toxic, non-carcinogenic, and environmentally friendly. Various fluorinated solvents meet these requirements.

A fluorinated solvent is generally any solvent that contains fluorine in its chemical make-up. It is believed that the fluorinated solvent is surface active and provides a barrier to diffusion of water into the polyisocyanate. Any suitable fluorinated solvent may be used in accordance with the invention. The fluorinated solvent should be miscible with the polyisocyanate. Typically the fluorinated solvent will have an evaporation rate of at least 0.1 and more typically between 0.1 and 3.0. The evaporation rate is based on the evaporation rate of n-butyl acetate being 1.0. In one embodiment, the solubility of water in the fluorinated solvent is less than about 5%. and more typically between 0 and 3%.

Preferred fluorinated solvents include mixtures of chlorinated benzotrifluoride and a perfluorinated liquid. Even more preferred fluorinated solvents include mixtures of mono- or dichlorobenzotrifluoride with a perfluoro aliphatic or cycloaliphatic alkane, a perfluoroalkylcycloalkane, a perfluoro-N-alkylmorpholine, a perfluorocyclic ether, or a perfluoro polyether. Other preferred fluorinated solvents used for this invention include one or more fluorinated compounds containing at least one aromatic moiety and having a boiling point between about 100° C. and about 140° C. (typically between about 100° C. and about 120° C.). This latter class of compounds includes, for example, fluorinated mono-, di- and trialkyl aromatic compounds, including xylene and toluene derivatives. Preferred among these compounds are fluoroalkyl-substituted compounds, such as hexafluoroxylene, benzotrifluoride, and para-chlorobenzotrifluoride. Such compounds were commercially available, for example, under the OXSOL® trade-name from Occidental Chemical Corp., Grand Island, N.Y. A particularly preferred fluorinated solvent is p-chlorobenzotrifluoride also referred to as PCBTF or Benzene, 1-chloro-4(trifluoromethyl)-. This particularly suitable p-chlorobenzotrifluoride is OXSOL® 100, which is currently commercially available from IsleChem, Grand Island, N.Y.

Another factor in the choice of p-chlorobenzotrifluoride is the VOC that is released from the coating when it is applied. In solvent borne coating systems, there is a desire to reduce volatile organic compounds in order to comply with environmental requirements. One method of reducing VOC is to use exempt solvents, which are solvents that are not calculated as a VOC emission. p-chlorobenzotrifluoride is determined to be an exempt solvent from VOC regulations in the United States.

The base composition comprising parts (a)(1), (a)(2) and (a)(3) typically comprises up to about 40% by weight (based on the sum of parts (a)(1), (a)(2) and (a)(3)) fluorinated solvent, even more typically between 1 and 20% by weight fluorinated solvent; and most typically between about 5 to 15% by weight fluorinated solvent. The fluorinated solvent may be used alone or in combination with other solvents known in the art.

Although, the water dispersible polyisocyanate composition of the invention is particularly suitable as a component of a two-component water-based aqueous polymer dispersion coating, it should be understood that the water dispersible polyisocyanate composition described as the first component of such two-component coating may be used alone as a coating material, adhesive, or impregnating agent.

In a two-component polyurethane coating composition, the water dispersible polyisocyanate composition of the invention may be used as an additive, for example, a crosslinking agent or hardener, for aqueous polymer dispersions or emulsions. To produce films, two-components are mixed, I) the water dispersible polyisocyanate, which may or may not be blocked, and fluorinated solvent mixture; and II) a dispersion of aqueous polymers. While it is desirable in the present invention that the fluorinated solvent be incorporated into the water dispersible polyisocyanate component, it is not outside the scope of the present invention for the fluorinated solvent to be added at any suitable time during processing of a two-component polyurethane coating. The polymers may be, for example, polyurethane or polymers obtained by radical polymerization or by polycondensation polymerization (for example polyesters) or any other polymers containing functional groups reactive with NCO functional groups.

Simple mixing by using mechanical devices or simple hand mixing of the water dispersible polyisocyanate compositions of the invention allows them to be finely dispersed into aqueous emulsions or dispersions. The emulsions obtained in accordance with the invention exhibit improved pot-life.

The mixture of the dispersions, which may also contain pigments and fillers, is then deposited on a substrate in the form of a film with the aid of conventional techniques for applying industrial coatings. When the preparation contains blocked isocyanates the combination of film plus substrate is cured at a sufficient temperature to ensure the de-blocking of the isocyanate functional groups and the condensation of the latter with the hydroxyl groups of the aqueous polymer dispersion particles.

In the present description the particle size characteristics frequently refer to notations of the dₙ type, where n is a number from 1 to 99; this notation is well known in many technical fields but is a little rarer in chemistry, and therefore it may be useful to give a reminder of its meaning. This notation represents the particle size such that n % (by weight, or more precisely on a mass basis, since weight is not a quantity of matter but a force) of the particles are smaller than or equal to the said size.

In accordance with the invention the mean sizes (d₅₀) of the emulsion of the water dispersible polyisocyanate composition and the aqueous polymer dispersion is less than 1000 nm, typically less than 500 nm and is most typically from about 50 nm to 200 nm. Preferred aqueous polymer dispersions employed in combination with these emulsions have mean sizes measured by quasi-elastic scattering of light which are between 20 nm and 200 nm and more generally between 50 nm and 150 nm.

When these reactive dispersions are mixed at high a concentration in water, which is generally the case, physical or chemical instability in time is observed in the mixtures of the two dispersions. To give an example, this instability is reflected in aggregation and macroscopic separation, to sometimes give, on the one hand, a fluid phase and, on the other hand, a very viscous phase. This results not only in it being impossible to preserve (store) these mixtures, but also in extreme difficulty in applying this mixture to the surface that it is desired to cover according to the usual techniques for the application of paints and varnishes. If these unstable mixtures are applied onto a substrate, such as onto a sheet of glass or metal, the resulting film is not transparent but looks opaque and heterogeneous and is therefore not suitable.

An objective of the present invention is to provide compositions comprising an emulsion of a water dispersible polyisocyanate and an aqueous polymer dispersion which are physically stable for at least 2 to 24 hrs, typically 4 to 24, most typically 6 to 24 hrs. The other objective of the invention is to obtain, from these stable and fluid mixtures, films exhibiting good gloss, transparency and solvent resistance properties.

These objectives are attained by means of a composition comprising: at least a water dispersible polyisocyanate, a surface active agent, and fluorinated solvent which gives an aqueous emulsion whose mean particle size d₅₀ is less than 1000 nm, typically less than 500 nm and even more typically between 50 nm to 200 nm; and at least one aqueous polymer dispersion, typically a polyol or more typically a polyurethane dispersion, whose mean particle size is between 20 nm and 200 nm and more generally between 50 nm and 200 nm.

The ratio of the number of hydroxyl functional groups to the number of isocyanate functional groups, masked or otherwise, can vary very widely, as shown above. Ratios that are lower than the stoichiometry promote plasticity, while ratios that are higher than the stoichiometry produce coatings of great hardness. These ratios are typically in a range extending from 0.5 to 3.0, typically between 0.8 and 1.6, and even more typically between 1.0 and 1.4.

In the case of polyurethane dispersions, in the absence of reactive hydroxyl groups, no such criteria exist. As a general guiding principle, about 10% by weight of the isocyanate may be added to the coating composition as hardener. The water dispersible polyisocyanate composition may be typically added to an aqueous polymer dispersion in amounts from 0.5% to 30%, and more typically from 1% to 15% by weight, based on the polymer.

### Part (b)—Aqueous Polymer Dispersion

The aqueous polymer dispersion (b) is typically a hydrophilic polymer that contains chemical functions that can react with isocyanate groups.

While it is to be understood that any suitable aqueous polymer dispersion may be used in accordance with the invention, preferred aqueous polymer dispersions comprise a polyol and even more preferred aqueous polymer dispersions comprise a polyurethane dispersion.

In one embodiment of the invention, the preferred polyol is a polymer that contains at least 2 hydroxyl groups (phenol or alcohol) that typically have a proportion of hydroxyl of between 0.5 and 5, typically between 1 and 3% (by mass). Except in the case of the lattices, which will be recalled later, it typically contains between 2 to 20% by mass primary and secondary alcohol functional groups. However, it may additionally contain secondary or tertiary alcoholic functional groups (in general at most about 10, typically at most 5, more frequently at most two) which, in general, do not react or react only after the primary ones, this being in the order primary, secondary, and tertiary.

Polyoses or polyosides (starch, cellulose, gums (guar, carob, xanthan, etc.) of various kinds etc.) are to be avoided, especially in solid form. In the form of a texturing agent, and insofar as this does not interfere with the conversion into emulsion and the stability of the latter, they can, however, be employed to impart particular properties (for example, thixotropy, etc.). The polymer backbone may be of diverse chemical nature, especially acrylic, polyester, alkyd, polyurethane or even amide, including urea.

The polyol may contain anionic groups, especially carboxylic or sulphonic, or may not contain any ionic group.

The polyol can already be in an aqueous or water-soluble or water-dispersible medium.

It may be an aqueous solution (which may in particular be obtained after neutralization of the ionic groups) or an emulsion of the polymer in water or a dispersion of latex type.

It seems possible to disperse a standard hydrophobic polyisocyanate in a water-soluble polyol in some conditions of formulation (especially with a ratio of pigment to paint binder which is suitable). However the use of standard hydrophobic polyisocyanates with water-dispersed polyols (resin emulsion or latex types) frequently presents problems of incompatibility (flocculation, appearance of several phases etc.). One of the many advantages of the preparation according to the invention is that it offers a great freedom of choice for the formulation (physical form of the polyol, pigment-to-binder ratio, ease of incorporation into aqueous media).

In particular it is typically possible to employ lattices, especially nano-lattices (that is to say lattices in which the particle size is nanometric [more precisely, in which the d₅₀ is at most equal to about 100 nm]).

Thus, according to one of the particularly preferable applications of the present invention, the polyol is typically a latex of nanometric size exhibiting the following characteristics:

d₅₀ of between 15 nm and 60 nm, typically between 20 nm and 40 nm

carboxylate functional group from 0.5 to 5% by mass

-ol functional group: between 1 and 4% typically between 2 and 3%

solid content: between 25 and 40%

a d₈₀ smaller than 1 micrometer.

In addition, the lattices, above all when their glass transition point is lower than 0° C., typically than −10° C., typically than −20° C., make it possible to obtain even with aromatic isocyanates good quality of resistance to inclement weather and especially to temperature variations.

The molar ratio between the free isocyanate functional groups and the hydroxyl functional groups is between 0.5 and 3.0, typically between 0.8 and 1.6, and even more typically between 1 and 1.4.

The lattices (which are not functionalized in respect of isocyanate which are optionally masked) that are described in the French Patent Application filed on 28 Apr. 1995 No. 95/05123 and in the European Patent Reflex Application No. EP 0,739,961 give very good results.

Thus the latex particles typically exhibit an acidic (typically carboxylic) functional group content that is accessible of between 0.2 and 1.2 milliequivalents/gram of solid content and they exhibit an accessible alcoholic functional group content of between 0.3 and 1.5 milliequivalents/gram.

Thus, as indicated in this document the lattices consisting of particles carrying functional group(s) according to the invention are preferred, are hydrophobic and typically have a size (d₅₀) that is generally between 50 nm and 150 nm. They are calibrated, mono-disperse, and present in the latex in a proportion of a quantity varying between 0.2 to 65% by weight of the total weight of the latex composition.

More preferred aqueous polymer dispersions containing reactive hydrogen groups are the known polyester polyols, polyether polyols, polyhydroxyl polyacrylates, polycarbonates containing hydroxyl groups, and mixtures thereof. In addition to these preferred polyhydroxyl compounds, it is also possible to use polyhydroxy polyacetals, polyhydroxy polyester amides, polythioether containing terminal hydroxyl groups or sulphydryl groups or at least difunctional compounds containing amino groups, thiol groups or carboxy groups. Mixtures of the compounds containing reactive hydrogen groups may also be used.

In a preferred embodiment of the invention, the film forming aqueous polymer dispersion reactable with the water dispersible polyisocyanate is an acrylic resin, which may be a polymer or oligomer. The acrylic polymer or oligomer typically has a number average molecular weight of 500 to 1,000,000, and more typically of 1000 to 20,000 grams/mole. Acrylic polymers and oligomers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such resins include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

Modified acrylics can also be used. Such acrylics may be polyester-modified acrylics or polyurethane-modified acrylics, as is well-known in the art. Polyester-modified acrylics modified with ε-caprolactone are described in U.S. Pat. No. 4,546,046 of Etzell et al, the disclosure of which is incorporated herein by reference. Polyurethane-modified acrylics are also well-known in the art. They are described, for example, in U.S. Pat. No. 4,584,354, the disclosure of which is also incorporated herein by reference.

Polyesters having active hydrogen groups such as hydroxyl groups can also be used as the film forming aqueous polymer dispersion in the composition according to the invention. Such polyesters are well-known in the art, and may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

Polyurethanes having active hydrogen functional groups are also well-known in the art. They are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). They can be provided with active hydrogen functional groups by capping the polyurethane chain with an excess of diol, polyamine, amino alcohol, or the like. These polyurethanes may be dispersed in water and available as polyurethane dispersions (PUDs) stabilized with hydrophilic anionic functionality, such as carboxylic acids. In one embodiment, the polyurethane polymer dispersion comprises greater than 5 wt %, more typically from about 10 to about 15 wt %, n-methylpyrrolidone based on the total amount of the aqueous polymer dispersion

Although polymeric or oligomeric active hydrogen components are often preferred, lower molecular weight non-polymeric active hydrogen components may also be used in some applications, for example aliphatic polyols (e.g., 1,6-hexane diol), hydroxylamines (e.g., monobutanolamine), and the like.

In a two-component system the acrylic polyol may function as a film forming polymer. However, the film forming component of a two-component system in accordance with the invention may also comprises additional film forming polymers. The film forming polymer will generally comprise at least one functional groups selected from the group consisting of active hydrogen containing groups, epoxide groups, and mixtures thereof. The functional group is typically reactive with one or more functional groups of the hydrophobic polyisocyanate oligomer.

Two-component polyurethane coatings of the invention are particularly useful, for example, as high gloss coating materials or impregnating materials, for example, for paint or coloring.

Two-component polyurethane or polyol coatings of the invention may be used on a variety of substrates, for example, plastic, leather, paper, wood, metal, or any substrate where a high gloss film is desired.

In one embodiment, the present invention is directed to an article comprising a substrate and a coating disposed on at least a portion of the substrate, wherein the coating comprises the cured reaction product of a reactive coating composition according to the present invention.

In order to further illustrate the invention and the advantages thereof, the following non-limiting examples are given.

### Example 1

Different levels (1, 5, 10 and 15% w/w) of p-chlorobenzotrifluoride (“PCBTF”, OXSOL® 100 fluorinated solvent, Occidental Chemical Corp., Grand Island, N.Y.)) were premixed into a water emulsifiable polyisocyanate oligomer/surfactant blend (Rhodocoat® EZM-502 isocyanate, Rhodia Inc., Cranbury, N.J.) on a roller mixer for at least 2 hrs prior to use and then used in the following EXAMPLES.

### Example 2

### Improved Emulsification

Water dispersible polyisocyanate/PCBTF premixes were emulsified in a polyurethane dispersion (“PUD1”) at 1000 rpm in a vial with a suitable overhead paddle mixer at a ratio of 10 grams of a polyurethane dispersion per 1 gram water dispersible polyisocyanate. PUD1 is a standard commercially available aqueous polyurethane dispersion at about 35% solids concentration and containing about 10% by mass of N-methylpyrrolidone (NMP).

Increasing levels of PCBTF in the water dispersible polyisocyanate premix made the water dispersible polyisocyanate premix noticeably easier to emulsify in the polyurethane dispersion. The 10 grams of a polyurethane dispersion is viscous and normally difficult to emulsify into polyurethane dispersions, and even under mechanical agitation resulted in droplets 2-5 μm in size. The addition of PCBTF sharply reduced the viscosity of the water dispersible polyisocyanate, facilitated dispersion in the polyurethane dispersion, and resulted in a finer emulsion structure (<1 μm).

Water dispersible polyisocyanate/PCBTF premixes were also hand mixed into the polyurethane dispersion for 3 min. using a metallic spatula and the quality of mixing criteria were measured. In this typical application mode, water dispersible polyisocyanate with greater than 5 wt % PCBTF spontaneously emulsified with the polyurethane dispersion to give a stable emulsion for a time period in excess of the 4-6 hours application window. The ease of hand mixing was evaluated according to several parameters, that is ease of mixing, avoiding formation of lumps or aggregates, avoiding formation of strings, and settling of aggregates after 10 minutes of mixing, and ranked on a scale of 1 to 5, wherein best=0; and worst=5. Results indicating the ease of mixing of the water dispersible polyisocyanate with different levels of PCBTF are set forth in Table 1 below.

TABLE 1
Ease of hand mixing of polyurethane dispersion with water
dispersible polyisocyanate/PCBTF premixes having different PCBTF
contents. (Best = 0; Worst = 5).

| | Sample No. | | | |
|---|---|---|---|---|
| | R664-32-04 | R664-32-05 | R604-23-07 | R604-23-09 |
| | % PCBTF | | | |
| | 0% | 1% | 5% | 10% |
| Ease of | 5 | 4 | 1 | 0 |
| mixing | | | | |
| avoiding | 4 | 3 | 1 | 0 |
| lumps or | | | | |
| aggregates | | | | |
| avoiding | 0 | 0 | 0 | 0 |
| strings | | | | |
| settling of | 3 | 1 | 0 | 0 |
| aggregates | | | | |
| 10 min after | | | | |
| mixing | | | | |

### Example 3

### Improved Film Morphology and Gloss

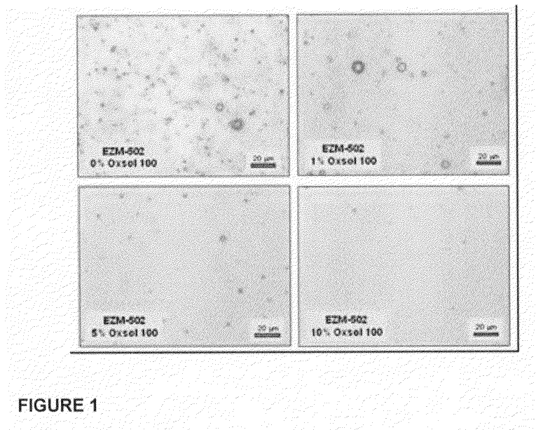

Films cast from emulsions (10 g PUD1/1 g EZM-502) of polyurethane dispersion and water dispersible polyisocyanate/PCBTF premixes were emulsified at 1000 rpm and cast on glass panels (wet film thickness of 15 mils). FIG. 1 show optical micrographs of the cast films. The micrographs show a progressive improvement in film morphology, that is, a progressive reduction in the density of film heterogeneities, with increasing PCBTF content. As discussed above these heterogeneities lend the “matte finish” in the visual aspect of the film and may be due to presence of aggregates of polyurethane dispersion or bubbles trapped in the film.

The dramatically reduced spatial density of heterogeneities in the film leads to high gloss films at 10-15% PCBTF content. Gloss measurements were performed with the Byk Gardner Gloss meter on films cast on Black Leneta charts. The results are set forth in Tables 2A and 2B below. Gloss increased with film thickness and increasing PCBTF content, with highest levels of gloss (20° gloss=73.3 and 60° gloss=88.0) being achieved with for 15 mil wet thickness films containing 10% PCBTF.

### Table 2A and 2B Gloss measurements on films cast from polyurethane dispersion/water dispersible polyisocyanate emulsions with varying PCBTF content.

TABLE 2A
Draw Down Gage: 10 mil Wet film Thickness (254 μm)

| | % PCBTF | | | |
|---|---|---|---|---|
| Sample No. | 100 | 20° | 60° | 85° |
| R664-23-07 | 0 | 26.2 ± 0.8 | 62.3 ± 0.6 | 90.0 ± 0.3 |
| R664-23-01 | 1 | 28.8 ± 2.6 | 64.1 ± 1.5 | 92.0 ± 0.6 |
| R664-23-03 | 5 | 52.2 ± 1.9 | 78.7 ± 0.5 | 96.0 ± 0.5 |
| R664-23-05 | 10 | 60.1 ± 1.8 | 83.2 ± 0.2 | 97.0 ± 0.2 |

TABLE 2B
Draw Down Gage: 15 mil Wet Film Thickness (381 μm)

| | % PCBTF | | | |
|---|---|---|---|---|
| Sample No. | 100 | 20° | 60° | 85° |
| R664-62-13 | 1 | 36.4 ± 0.6 | 71.3 ± 1.0 | 96.5 ± 1.8 |
| R664-62-15 | 5 | 56.2 ± 0.5 | 80.0 ± 0.1 | 98.2 ± 0.2 |
| R664-62-17 | 10 | 73.3 ± 3.6 | 88.0 ± 0.4 | 97.2 ± 2.6 |

### Example 4

### Comparative Performance with Other Solvents

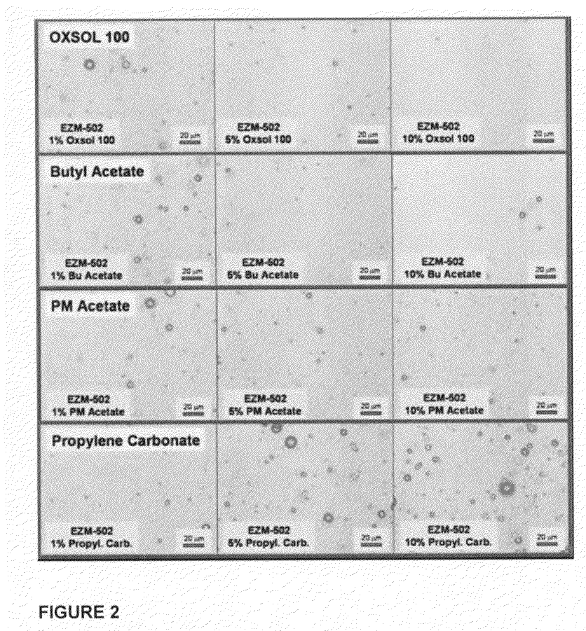

Comparison of film morphology at different solvent content was performed for several different solvents, that is, butyl acetate, 1-methoxy 2-propanol acetate (CAS #: 108-65-6 (“PM Acetate”)), and propylene carbonate (CAS # 108-32-7). All the films were cast (15 mils wet film thickness) from emulsions (10 g PUD1:1 g EZM-502) of polyurethane dispersion and water dispersible polyisocyanate with different solvent content that had been emulsified at 1000 rpm. Optical micrographs of the cast films are shown in FIG. 2. The micrographs show that PCBTF and butyl acetate yielded higher gloss films with improved film morphology with increasing solvent content from 1-10%, while increasing PM Acetate and propylene carbonate content led to progressively poorer film morphologies. The spatial density of heterogeneities stays relatively unperturbed with PM Acetate content, while the morphology with films with propylene carbonate get progressively worse with increased solvent content.

While not wishing to be bound by theory, this may be explained by the molecular structure and the solvent properties of the solvents, as summarized below:

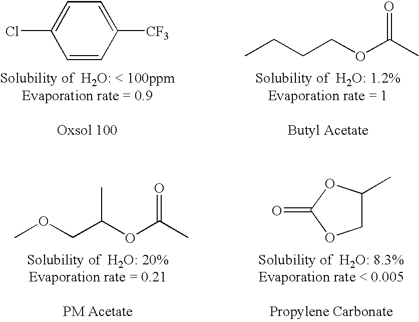

The key parameters appear to be the solubility of water and the evaporation rate (from literature). The evaporation rates are relative to that of butyl acetate. This is generally acceptable in the industry to compensate for environmental variables such as humidity, airflow, temperature, etc.

PCBTF has a relatively low water solubility and an evaporation rate equivalent to that of butyl acetate and gives clear films at 10% concentration. Butyl acetate has a nominally low solubility of water ˜1.2% and gives increasingly better films visually with concentration but to a lesser extent than those with PCBTF. PM Acetate has very high solubility of water and lower evaporation rate that may explain poor film morphology. Propylene carbonate has lower solubility of water than PM Acetate but extremely low evaporation rate. This retention of water has deleterious effects that become progressively worse with solvent content. Gloss measurements are shown in Tables 3A-3D below.

### Tables 3A-3D. Gloss of films of polyurethane/water dispersible polyisocyanate emulsions with different solvents and different solvent content.

TABLE 3A

| Sample No. | % PCBTF | 20° | 60° | 85° |
|---|---|---|---|---|
| R664-62-13 | 1 | 36.4 ± 0.6 | 71.3 ± 1.0 | 96.5 ± 1.8 |
| R664-62-15 | 5 | 56.2 ± 0.5 | 80.0 ± 0.1 | 98.2 ± 0.2 |
| R664-62-17 | 10 | 73.3 ± 3.6 | 88.0 ± 0.4 | 97.2 ± 2.6 |

TABLE 3B

| | % Butyl | | | |
|---|---|---|---|---|
| Sample No. | Acetate | 20° | 60° | 85° |
| R664-62-07 | 1 | 40.1 ± 3.2 | 71.8 ± 1.0 | 96.3 ± 2.0 |
| R664-62-09 | 5 | 64.0 ± 2.5 | 83.3 ± 0.6 | 99.3 ± 0.2 |
| R664-62-11 | 10 | 64.7 ± 0.5 | 83.8 ± 0.1 | 99.6 ± 0.2 |

TABLE 3C

| | % PM | | | |
|---|---|---|---|---|
| Sample No. | Acetate | 20° | 60° | 85° |
| R664-57-19 | 1 | 30.9 ± 0.6 | 65.1 ± 0.3 | 95.2 ± 0.5 |
| R664-57-21 | 5 | 29.8 ± 2.8 | 63.1 ± 1.8 | 94.6 ± 1.0 |
| R664-57-23 | 10 | 24.9 ± 0.5 | 60.7 ± 0.5 | 94.6 ± 0.1 |

TABLE 3D

| | % Propylene | | | |
|---|---|---|---|---|
| Sample No. | Carbonate | 20° | 60° | 85° |
| R664-62-1 | 1 | 38.1 ± 3.2 | 68.7 ± 1.5 | 96.2 ± 0.3 |
| R664-62-3 | 5 | 27.2 ± 2.9 | 61.3 ± 1.2 | 92.5 ± 0.2 |
| R664-62-5 | 10 | 19.8 ± 1.3 | 51.1 ± 1.8 | 87.2 ± 0.9 |

### Example 5

### High Gloss Films with a Range of Polyols/PUDs

The following emulsions of water dispersible polyisocyanate (EZM-502) and water dispersible polyisocyanate/PCBTF premix with an acrylic polyol (04JLR85-4 polyol latex, Nanolatex), with PUD1 and with a second polyurethane dispersion (PUD2, a commercially available hydroxyl-functional polyurethane dispersion containing 35% solids by mass and about 12% N-methylpyrrolidone) were made:
(A) polyurethane dispersion (PUD1)/water dispersible polyisocyanate
(B) polyurethane dispersion (PUD1)/water dispersible polyisocyanate, 10% PCBTF,
(C) polyol latex (04JLR854)/water dispersible polyisocyanate, 10% PCBTF, and
(D) polyurethane dispersion (PUD2)/water dispersible polyisocyanate, 10% PCBTF.

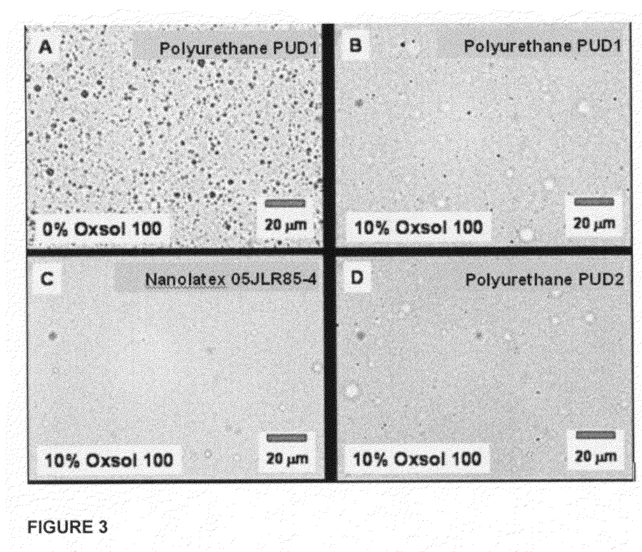

The emulsions were prepared at 1000 rpm using 1 g of EZM-502 per 10 g of polyol latex or polyurethane dispersion and cast with a 15 mil wet film thickness. FIG. 3 shows optical micrographs of each of the films, in which the films cast from emulsions containing 10% PCBTF exhibit improved, more homogeneous, film morphology.

1. A water dispersible polyisocyanate composition, comprising:
(a)(1) one or more hydrophobic polyisocyanate oligomers,
(a)(2) one or more surface active agents, and
(a)(3) one or more fluorinated solvents.

2. The composition of claim 1, wherein the composition comprises:
from greater than 0 to less than 100 wt % of the one or more hydrophobic isocyanate oligomers,
from greater than 0 to about 20 wt % of the one or more surface active agents, and
from greater than 0 to about 40 wt % of the one or more fluorinated solvent.

3. The composition of claim 1, wherein the one or more hydrophobic isocyanate oligomers comprise one or more polyisocyanate oligomers derived from polycondensation of one or more diisocyanate or triisocyanate monomers.

4. The composition of claim 3, wherein the one or more monomers comprise monomers selected from 1,6-hexamethylene diisocyanate, 4,4′ bis-(isocyanato cyclohexyl)methane, bis(isocyanato-methylcyclohexane) cyclobutane-1,3-diisocyante, cyclohexane-1,3-diisocyanate, cyclohexane-1,4-diisocyanate; norbornane diisocyanate; isophorone diisocyanate, 3-isocyanatomethyl-3,5,5-trimethylcyclo-hexylisocyanate, -2,4- or 2,6-toluene diisocyanate; 2,6-4,4′-diphenylmethane diisocyanate; 1,5-naphthalene diisocyanate, p-phenylene diisocyanate, and mixtures thereof.

5. The composition of claim 4, wherein the one or more monomers comprise 1,6-hexamethylene diisocyanate.

6. The composition of claim 1, wherein the polyisocyanate oligomers have a combined average NCO functionality greater than 2.

7. The composition of claim 1, wherein the one or more surface active agents comprise one or more surfactant compounds that comprise, per molecule of surfactant compound, an anionic functional group, a polyalkylene oxide chain fragment, or an anionic functional group and a polyalkylene oxide chain fragment.

8. The composition of claim 1, wherein the one or more surface active agents comprise one or more surfactant compounds according to formula (I): 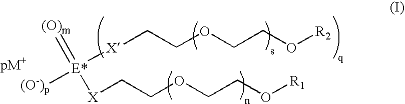
wherein:
q is 0 or 1;
p is 1 or 2;
m is 0 or 1;
the sum: 1+p+2m+q is equal to three or to five;
X and X′ are each independently divalent groups;
s is an integer from 1 to 30;
n is an integer from 1 to 30;
E is a carbon, phosphorus, or sulfur atom; and
R₁ and R₂ are each independently hydrocarbon radicals.

9. The composition of claim 1, wherein E is a phosphorus atom; and R₁ and R₂ are each independently alkyl.

10. The composition of claim 1, wherein the one or more surface active agents comprise one or more polyisocyanate oligomers that comprise, per molecule of oligomer, an anionic functional group, a polyalkylene oxide chain fragment, or an anionic functional group and a polyalkylene oxide chain fragment.

11. The composition of claim 1, wherein the fluorinated solvent has an evaporation rate of at least about 0.1 times the evaporation rate of butyl acetate.

12. The composition of claim 1, wherein the solubility of water in the fluorinated solvent is less than about 5%.

13. The composition of claim 1, wherein the fluorinated solvent comprises p-chlorobenzotrifluoride.

14. A composition, comprising water and the composition of claim 1 in the form of an aqueous emulsion of the composition of claim 1.

15. The composition of claim 14, wherein emulsion exhibits a mean polyisocyanate oligomer particle size d₅₀ is less than about 1 micron.

16. An aqueous reactive coating composition, comprising a mixture of:
(a)(1) one or more polyisocyanate oligomers that are not surface active,
(a)(2) one or more surface active agents, and
(a)(3) one or more fluorinated solvents, and
(b) an aqueous polymer dispersion.

17. The composition of claim 16, wherein the one or more isocyanate oligomers comprise one or more polyisocyanate oligomers derived from polycondensation of one or more diisocyanate or triisocyanate monomers.

18. The composition of claim 17, wherein the one or more monomers comprise monomers selected from 4,4′ bis-(isocyanato cyclohexyl)methane, Bis(isocyanato-methylcyclohexane) cyclobutane-1,3-diisocyante, cyclohexane-1,3-diisocyanate, cyclohexane-1,4-diisocyanate; norbornane diisocyanate; -isophorone diisocyanate, 3-isocyanatomethyl-3,5,5-trimethylcyclo-hexylisocyanate, -2,4- or 2,6-toluene diisocyanate; 2,6-4,4′-diphenylmethane diisocyanate; 1,5-naphthalene diisocyanate, p-phenylene diisocyanate, and mixtures thereof.

19. The composition of claim 18, wherein the one or more monomers comprise 1,6-hexamethylene diisocyanate.

20. The composition of claim 16, wherein the polyisocyanate oligomers have a combined average NCO functionality greater than 2.

21. The composition of claim 16, wherein the one or more surface active agents comprise one or more surfactant compounds that comprise, per molecule of surfactant compound, an anionic functional group, a polyalkylene oxide chain fragment, or an anionic functional group and a polyalkylene oxide chain fragment.

22. The composition of claim 16, wherein the one or more surface active agents comprise one or more surfactant compound according to formula (I): 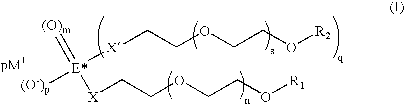
wherein:
q is 0 or 1;
p is 1 or 2;
m is 0 or 1;
the sum: 1+p+2m+q is equal to three or to five;
X and X′ are each independently divalent groups;
s is an integer from 1 to 30;
n is an integer from 1 to 30;
E is a carbon, phosphorus, or sulfur atom; and
R₁ and R₂ are each independently hydrocarbon radicals.

23. The composition of claim 22, wherein E is a phosphorus atom and R₁ and R₂ are each independently alkyl.

24. The composition of claim 16, wherein the one or more surface active agents comprise one or more polyisocyanate oligomers that comprise, per molecule of oligomer, an anionic functional group, a polyalkylene oxide chain fragment, or an anionic functional group and a polyalkylene oxide chain fragment.

25. The composition of claim 16, wherein the fluorinated solvent has an evaporation rate of at least about 0.1 times the evaporation rate of butyl acetate.

26. The composition of claim 16, wherein the solubility of water in the fluorinated solvent is less than about 5%.

27. The coating composition of claim 16, wherein the aqueous polymer dispersion is an aqueous polyurethane dispersion.

28. The composition of claim 27, wherein dispersion comprises greater than 5 wt % n-methylpyrrolidone based on the total amount of the aqueous polymer dispersion.

29. The coating composition of claim 16, wherein the polymer dispersion is an aqueous polyol dispersion.

30. An article comprising a substrate and a coating disposed on at least a portion of the substrate, wherein the coating comprises the cured reaction product of a reactive coating composition according to claim 16.
